(19) United States
(12) Patent Application Publication
(10) Pub. No.: US 2020/0088184 A1
(43) Pub. Date: Mar. 19, 2020

(54) ELECTROMAGNET MEMBRANE PUMP/TRANSDUCER SYSTEM AND METHODS TO MAKE AND USE SAME

(71) Applicant: Clean Energy Labs, LLC, Austin, TX (US)

(72) Inventor: Joseph F. Pinkerton, Austin, TX (US)

(73) Assignee: Clean Energy Labs, LLC, Austin, TX (US)

(21) Appl. No.: 16/075,719

(22) PCT Filed: Aug. 3, 2018
(86) PCT No.: PCT/US2018/045247

§ 371 Date: Aug. 6, 2018

Related U.S. Application Data
(60) Provisional application No. 62/541,543, filed on Aug. 4, 2017.

(51) Int. Cl. F04B 43/04; F04B 17/04; F04B 35/04; H01F 7/16; H04R 13/00; H04R 7/02

(52) U.S. Cl. CPC F04B 43/043; F04B 17/044; H04R 7/02; H01F 7/1638; H04R 13/00; F04B 35/045

(57) ABSTRACT

Electromagnet venturi pump/transducer systems and methods to make and use same. The membrane is made from a material that can be, for example, a steel membrane, having a ferrite disk that is pulled by the electromagnet to a set point and then the stiff membrane is oscillated about that set point.

### CROSS-REFERENCE TO RELATED PATENT APPLICATIONS

This application claims priority to provisional U.S. Patent Application Ser. No. 62/541,543, filed Aug. 4, 2017, entitled “Electromagnet Membrane Pump/Transducer System And Methods To Make And Use Same,” which provisional patent application is commonly assigned to the Assignee of the present invention and is hereby incorporated herein by reference in its entirety for all purposes (including appendices).

This application is related to U.S. Pat. No. 9,516,426, issued Dec. 6, 2016 to Joseph F. Pinkerton, and entitled “Electrostatic Membrane Pump/Transducer And Methods To Make And Use Same” (“the Pinkerton '426 Patent”), which issued from U.S. patent application Ser. No. 14/857,179, filed Sep. 17, 2015, which was a continuation-in-part of U.S. patent application Ser. No. 14/047,813, filed Oct. 7 2013, which is entitled “Electrically Conductive Membrane/Pump Transducer And Methods To Make And Use Same.” That application is a continuation-in-part of International Patent Application No. PCT/2012/058247, filed Oct. 1, 2012, which designated the United States and claimed priority to provisional U.S. Patent Application Ser. No. 61/541,779, filed on Sep. 30, 2011, each of which patent applications is entitled “Electrically Conductive Membrane Transducer And Methods To Make And Use Same.” All of these above-identified patent applications are commonly assigned to the Assignee of the present invention. The Pinkerton '426 Patent is hereby incorporated herein by reference in its entirety for all purposes.

This application is also related to U.S. patent appliaction Ser. No. 15/647,073, filed Jul. 11, 2017, to Joseph Pinkerton, and entitled “Electrostatic Membrane Pump/Transducer And Methods To Make And Use Same” (“the Pinkerton '073 Application”). The Pinkerton '073 Application is hereby incorporated herein by reference in its entirety for all purposes.

### TECHNICAL FIELD

The present invention relates to electromagnet membrane pump/transducers, and more particularly, electromagnet venturi membrane-based pump/transducer systems and methods to make and use same.

### BACKGROUND

Conventional audio speakers compress/heat and rarify/cool air (thus creating sound waves) using mechanical motion of a cone-shaped membrane at the same frequency as the audio frequency. Most cone speakers convert less than 10% of their electrical input energy into audio energy. These speakers are also bulky in part because large enclosures are used to muffle the sound radiating from the backside of the cone (which is out of phase with the front-facing audio waves). Cone speakers also depend on mechanical resonance; a large “woofer” speaker does not efficiently produce high frequency sounds, and a small “tweeter” speaker does not efficiently produce low frequency sounds.

Thermoacoustic (TA) speakers use heating elements to periodically heat air to produce sound waves. TA speakers do not need large enclosures or depend on mechanical resonance like cone speakers. However, TA speakers are terribly inefficient, converting well under 1% of their electrical input into audio waves.

The present invention relates to an improved transducer (i.e., speaker) that includes an electrically conductive membrane such as, for example, a polymer membrane. In some embodiments, the transducer can be an ultrasonic transducer. An ultrasonic transducer is a device that converts energy into ultrasound (sound waves above the normal range of human hearing). Examples of ultrasound transducers include a piezoelectric transducers that convert electrical energy into sound. Piezoelectric crystals have the property of changing size when a voltage is applied, thus applying an alternating current (AC) across them causes them to oscillate at very high frequencies, thereby producing very high frequency sound waves.

The location at which a transducer focuses the sound can be determined by the active transducer area and shape, the ultrasound frequency, and the sound velocity of the propagation medium. The medium upon which the sound waves are carries can be any gas or liquid (such as air or water, respectively).

Graphene membranes (also otherwise referred to as “graphene drums”) have been manufactured using a process such as disclosed in Lee et al. Science, 2008, 321, 385-388. PCT Patent Appl. No. PCT/US09/59266 (Pinkerton) (the “PCT US09/59266 Application”) described tunneling current switch assemblies having graphene drums (with graphene drums generally having a diameter between about 500 nm and about 1500 nm). PCT Patent Appl. No. PCT/US11/55167 (Pinkerton et al.) and PCT Patent Appl. No. PCT/US11/66497 (Everett et al.) further describe switch assemblies having graphene drums. PCT Patent Appl. No. PCT/US11/23618 (Pinkerton) (the “PCT US11/23618 Application”) described a graphene-drum pump and engine system.

The Pinkerton '426 Patent described and taught an electrostatic venturi membrane-based pump/transducer (“EVMP”) system (alternatively referred to as an “electrostatic membrane-based venturi pump/transducer system”), including as illustrated in FIGS. 1-2 and 3A-3F. These FIGS. 1-2 and 3A-3F correspond to FIGS. 26-27 and 28A-28F, respectively, in the Pinkerton '426 Patent. FIG. 1 depicts an illustration of a side view of an enhanced and improved version of an electrostatic membrane-based venturi pump system (and audio speaker) 100 that includes twelve electrostatic membrane pump transducers (arranged in four column and three rows). The side view shows four of the electrostatic membrane pump transducers 100A-100D. FIG. 2 depicts illustrations of an overhead view of the illustration of the electrostatic membrane-based venturi pump system 100 and reflects the tops of the twelve electrostatic membrane pump transducers 100A-100L.

FIGS. 3A-3F depict illustrations of overhead views of an electrostatic membrane pump transducer (such as electrostatic membrane pump transducers 100A) at various levels. The six layers reflected in these levels are as follows:

An electrically conductive solid stator 103 with central hole 302, which has an overhead view depicted in FIG. 3C. Such electrically conductive solid stators 103 can be made of stainless steel.

Electrically conductive perforated stators 106, which has an overhead view depicted in FIG. 3F. The electrically conductive perforated stator 106 has multiple perforations 301. As shown in FIG. 1, electrostatic membrane pump transducers 100A has three levels of electrically conductive perforated stators 106. Such electrically conductive perforated stators 106 can be made of an electrically conductive material, such as stainless steel. In alternative embodiments, one of more of the electrically conductive perforated stators can be designed to have just one perforation (i.e., hole) that allows the fluid to flow from one side of an electrically conductive perforated stator to the other side of the electrically conductive perforated stator. For instance, the electrically conductive perforated stator can have one central hole similar to the electrically conductive solid stator 103, although the hole may be larger or offset.

Electrically conductive membrane frames 105, which has an overhead view depicted in FIG. 3E. As shown in FIG. 1, electrostatic membrane pump transducers 100A has seven instances of electrically conductive membrane frame 105. Such electrically conductive membrane frames 105 can be made of an electrically conductive material, such as stainless steel. The electrically conductive member frames 105 are frames that support the electrically conductive membranes 114 (shown in FIG. 1) and also electrically connect membranes 114 to an external electrical circuit. The electrically conductive membranes 114 can be made of Mylar coated with a slightly conductive material.

Insulating spacers 104, which overhead view is depicted in FIG. 3E. As shown in FIG. 1, electrostatic membrane pump transducers 100A has seven levels of insulating spacers 104. Such insulating spacers 104 can be made of an electrical insulator, such as fiberglass.

Insulating venturi spacer 102, which overhead view is depicted in FIG. 3B.

Venturi exit plate 101 with central hole 303 and optional nozzle (not shown), which overhead view is depicted in FIG. 3A.

As reflected in FIG. 1, each layer is stacked up along with the electrically conductive membranes 114. The layers are preferably joined together with some type of adhesive. Pre-cut (such as stamped out) sheets with multiple copies of each element can be assembled as a panel. FIG. 2 shows a panel with twelve electrostatic venturi membrane pumps. As noted above, electrically conductive perforated stators 106, electrically conductive solid stators 103, and the electrically conductive membrane frames 105 can be made of stainless steel, such as stainless steel that is laminated with two sheets of an insulating material like Mylar (which greatly reduces stator-stator and frame-stator sparking). (Voltages between a frame and stator can be a few to several kV).

As the electrically conductive membranes 114 move up (such as shown in electrostatic membrane pump transducer 100A in FIG. 1), an elevated pressure jet of air 110 (or other fluid as the case may be) is forced out of the hole 302 of electrically conductive solid stator 103, through the channel defined by the insulating venturi spacer 102, and through hole 303 of venturi exit plate 101. Because the velocity of the air increases as it moves from the top membrane chamber out hole 302 of electrically conductive solid stator 103, it creates a partial vacuum in the insulating venturi spacer 102 region and this draws in air 107 from the bottom of the device (on either side of the pump chamber). This air 107 combines with the high speed air jet exiting hole 302 of electrically conductive solid stator 103 and both exit out hole 303 of venturi exit plate 101.

Likewise, as electrically conductive membranes 114 move up (such as shown in electrostatic membrane pump transducer 100A in FIG. 1), air (or other fluid) moves upward in electrostatic membrane pump transducer 100A in FIG. 1 through perforations 301 of the electrically conductive perforated stators 106 such that the air (or other fluid) moves from the bottom side of an electrically conductive perforated stator 106 to the top side of the same electrically conductive perforated stator 106. Such movement of air (or other fluid) is shown by arrows 108. Sound or ultrasonic waves 112 are also produced by this movement of air.

When the motion of electrically conductive membrane 114 reverses (such as shown in electrostatic membrane pump transducer 100B in FIG. 1), air is drawn into the pump chamber of electrostatic membrane pump transducer 100B through hole 302 of electrically conductive solid stator 103. Such drawing of air into the pump chamber of electrostatic membrane pump transducer 100B through hole 302 of electrically conductive solid stator 103 also creates a vacuum that draws in more air 107. Moreover, air 107 has some inertia that makes it continue to move toward and out of hole 303 of venturi exit plate 101.

Likewise, as electrically conductive membranes 114 move down (such as shown in electrostatic membrane pump transducer 100B in FIG. 1), air (or other fluid) moves downward in electrostatic membrane pump transducer 100A in FIG. 1 through perforations 301 of the electrically conductive perforated stators 106 such that the air (or other fluid) moves from the top side of an electrically conductive perforated stator 106 to the bottom side of the same electrically conductive perforated stator 106. Such movement of air (or other fluid) is shown by arrows 109. Sound or ultrasonic waves 113 are also produced by this movement.

These two parts of the cycle result in a net pumping effect that draws air in from the bottom (or one side) and shoots it out the top (or the other side) of the device (this also creates a thrust in the opposite direction of the high speed air jet). The electrically conductive membranes 114 can operate at both sonic and ultrasonic frequencies. Ultrasonic frequencies are preferred due to higher pumping rates and the fact that the pumping sound is inaudible. By alternating the phase of half the electrostatic membrane pump transducers 100A-100L (180 degrees with respect to the other half), much of the sonic or ultrasonic sound of the pump array (as shown by sound or ultrasonic waves 112 and 113) can be cancelled out without affecting the net pumping rate.

The EVMP system 100 shown in FIGS. 1-2 and 3A-3F had pumps in series to increase pressure and flow through the venturi channel. The EVMP system 100 also has pumps operating out of phase to cancel unwanted ultrasonic signals emanating from the pumps.

### SUMMARY OF THE INVENTION

The present invention relates to electromagnet membrane pump/transducers, and more particularly, electromagnet venturi membrane-based pump/transducer systems and methods to make and use same. The membrane is a stiff membrane that can be, for example, a steel membrane, having a ferrite disk (which is mounted to the membrane) that is pulled by the electromagnet to a set point and then the stiff membrane is oscillated about that set point.

In general, in one aspect, the invention features an electromagnet venturi membrane-based pump/transducer that is operable to produce a flow of fluid. The electromagnet venturi membrane-based pump/transducer includes a membrane having a first side and a second side. The membrane is operable to move along an axis. The electromagnet venturi membrane-based pump/transducer further includes a ferromagnetic material. The membrane includes the ferromagnetic material, the ferromagnetic material is attached to the membrane, or both. The electromagnet venturi membrane-based pump/transducer further includes a perforated structure having a first side facing the first side of the membrane. The perforated structure has perforations to provide for the flow of the fluid through the perforated structure. The electromagnet venturi membrane-based pump/transducer further includes an electromagnet on the first side of the perforated structure such that the electromagnet is facing the ferromagnetic material. The electromagnet venturi membrane-based pump/transducer further includes a venturi plate positioned on the second side of the membrane. The electromagnet is operable to pull the membrane to a set point and then oscillate the membrane about this point. The oscillation of the membrane produces the flow of the fluid.

Implementation of the invention can include one or more of the following features:

The the ferromagnetic material can be attached to the membrane.

The ferromagnetic material can be a ceramic compound.

The ceramic compound can be ferrite.

The ferrite can be Fe₃O₄ or BaFe₁₂O₁₉.

The membrane can include the ferromagnetic material.

The membrane can include ferromagnetic steel.

The electromagnet can include a metal coil surrounded by a ferromagnetic material.

The metal coil can be a copper coil.

The ferromagnetic material can be ferrite or steel.

The electromagnet can be connected to an electronic circuit that controls the oscillation of the membrane.

The electronic circuit can provide electronic current having a DC component and an AC component.

The oscillation of the membrane can have a mechanical resonance of around 20 kHz.

The oscillation of the membrane can have a non-resonant mode.

The oscillation of the membrane can produce sound waves.

The oscillation of the membrane can produce ultrasonic waves.

The oscillation of the membrane can modulate deflection of the membrane at audio frequencies to produce an audio signal.

The fluid can be air.

The fluid can be water.

In general, in another aspect, the invention features a system that includes a plurality of the electromagnet venturi membrane-based pump/transducers set forth above.

Implementation of the invention can include one or more of the following features:

The system can be an audio system.

The system can be a pump.

The system can be a fan.

In general, in another aspect, the invention features a method. The method includes selecting an electromagnet venturi membrane-based pump/transducer. The electromagnet venturi membrane-based pump/transducer includes a membrane having a first side and a second side. The electromagnet venturi membrane-based pump/transducer further includes a ferromagnetic material. The membrane includes the ferromagnetic material, the ferromagnetic material is attached to the membrane, or both. The electromagnet venturi membrane-based pump/transducer further includes a perforated structure having a first side facing the first side of the membrane. The electromagnet venturi membrane-based pump/transducer further includes an electromagnet on the first side of the perforated structure such that the electromagnet is facing the ferromagnetic material. The electromagnet venturi membrane-based pump/transducer further includes a venturi plate positioned on the second side of the membrane. The method further includes utilizing the electromagnet to pull the membrane to a set point and then oscillating the membrane about this point. The oscillating of the membrane produces a flow of fluid. The flow of the fluid is through the perforations of the perforated structure.

Implementation of the invention can include one or more of the following features:

The ferromagnetic material can be attached to the membrane.

The ferromagnetic material can be a ceramic compound.

The ceramic compound can be ferrite.

The ferrite can be Fe₃O₄ or BaFe₁₂O₁₉.

The membrane can include the ferromagnetic material.

The membrane can include ferromagnetic steel.

The electromagnet can include a metal coil surrounded by a ferromagnetic material.

The metal coil can be a copper coil.

The ferromagnetic material can be ferrite or steel.

The step of utilizing the electromagnet can include providing an electronic current to the electromagnet.

The electronic current can have a DC component and an AC component.

The membrane can be oscillated at a mechanical resonance of around 20 kHz.

The membrane can be oscillated in a non-resonant mode.

The oscillating of the membrane can produce sound waves.

The oscillating of the membrane can produce ultrasonic waves.

The oscillating of the membrane can modulate deflection of the membrane at audio frequencies to produce an audio signal.

The fluid can be air.

The fluid can be water.

The step of selecting can include selecting a system that includes a plurality of the electromagnet venturi membrane-based pump/transducers.

The system can be an audio system.

The system can be a pump.

The system can be a fan.

### DESCRIPTION OF DRAWINGS

FIG. 1 depicts an illustration from FIG. 26 of the Pinkerton '426 Patent, which is a side view of an enhanced and improved version of an electrostatic membrane-based venturi pump system (and audio speaker) that includes twelve electrostatic membrane pump transducers (arranged in four column and three rows).

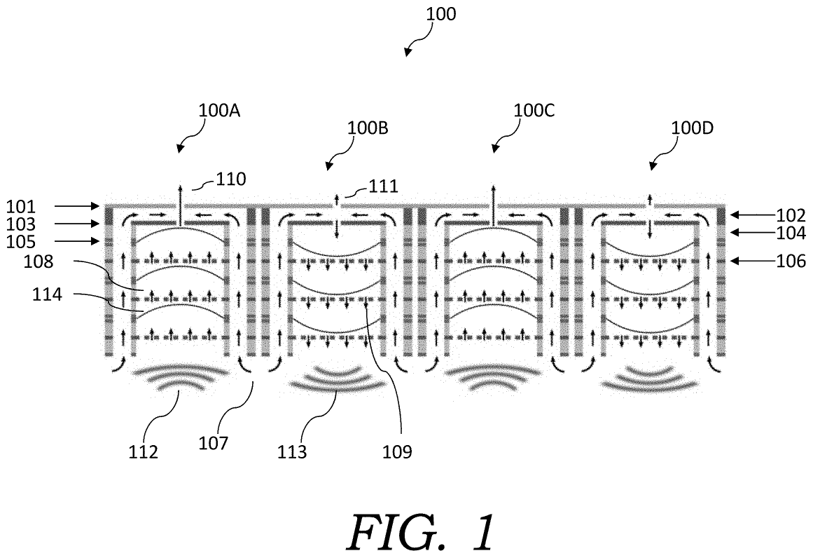

FIG. 2 depicts an illustration from FIG. 27 of the Pinkerton '426 Patent, which is an overhead view of the illustration of the electrostatic membrane-based venturi pump system shown in FIG. 1.

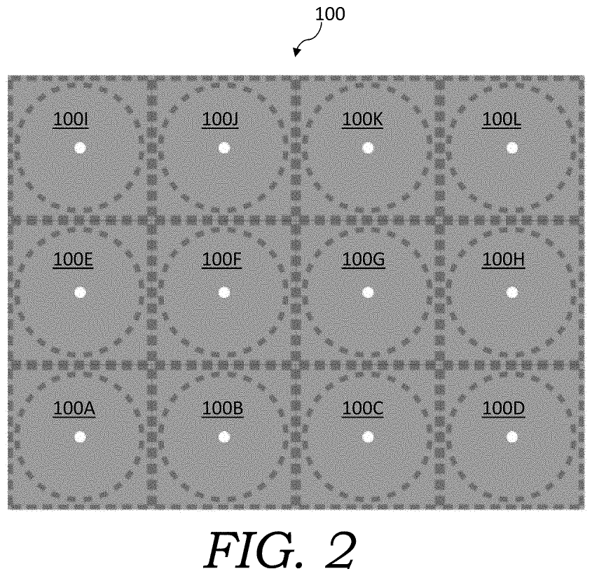

FIGS. 3A-3F depict illustrations from FIGS. 28A-28F, respectively, of the Pinkerton '426 Patent, which are overhead views of the electrostatic membrane pump transducer shown in FIG. 1 at various levels.

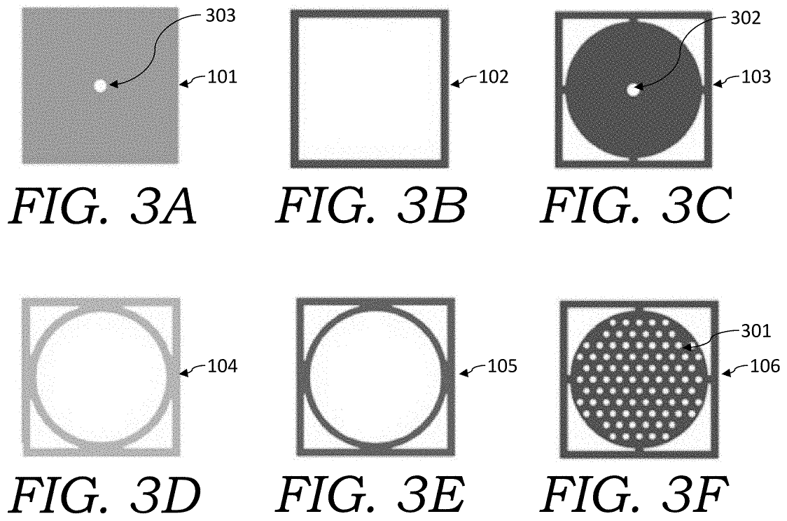

FIG. 4 illustrates an electromagnet membrane-based venturi pump/transducer (EVP) of the present invention.

### DETAILED DESCRIPTION

The present invention relates to electromagnet membrane-based venturi pump/transducer (EVP), systems that include such EVPs, and methods of use thereof.

In embodiments of the present invention, a small electromagnet is used to deflect a stiff (preferably steel) membrane at about 20 kHz and modulate this deflection at audio frequencies to produce an audio signal. The stiff membrane can have a ferrite (a ceramic compound that includes a mixed oxide of iron and one or more other metals) disk mounted to its surface. The ferrite disk has ferromagnetic properties such that it can be used in high-frequency electrical components. In some forms, the ferrite can be Fe₃O₄ or BaFe₁₂O₁₉, which are ferromagnetic materials used in magnetic applications.

In addition to its use in audio systems, the EVP and system having EVPs can also be used as a pump, fan, etc.

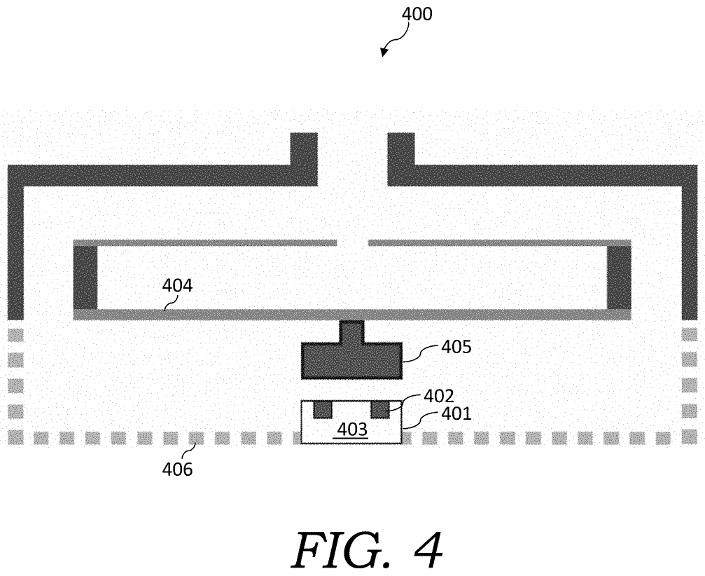

FIG. 4 shows an EVP 400 having an electromagnet 401 that includes a copper coil 402 and surrounding ferromagnetic material such as ferrite or steel 403. The EVP 400 further includes a stiff membrane 404 (such as a steel) having ferrite disk 405 disposed on the side facing electromagnet 401. Dotted line 406 is a support structure for electromagnet that is perforated to allow air to flow through it and into the EVP inlet.

Electromagnet 401 can just pull (not push), so generally it will pull the stiff membrane 404 having ferrite disk 405 toward it to some set point and then make stiff membrane 404 oscillate about this set point. (This can be accomplished with an electromagnet current having both a DC component and an AC component). The system of EVP 400 can be designed to mechanically resonate at around 20 kHz and can also be operated in a non-resonant mode. The ferromagnetic steel can be made of ferrite (which will reduce the eddy-current losses when operating at around 20 kHz).

The other features and components of the EVP of the present invention can be similar to those as disclosed and taught in the EVMPs of the Pinkerton '426 Patent and the Pinkerton '073 Application.

One advantage of the system and method of the present invention is that the magnetic force can be about 10-100× higher than the electrostatic force of the EVMPs, such as those disclosed and taught in the Pinkerton '426 Patent and the Pinkerton '073 Application. This results in higher pumping rates and also the ability to pressurize an enclosure to much higher pressures.

In an embodiment of the present invention, the EVP (or EVPs) can be mounted on the surface of a sealed air chamber, which allows for the EVPs to be utilized in a method of pressurizing and depressurizing the small sealed air chamber at audio frequencies to produce a large audio signal (much larger for a given size chamber than conventional cone speakers).

Another advantage of the electromagnet venturi pump/transducer (EVP) is it can operate at 5-30 volts and thus can use inexpensive off the shelf audio amplifiers.

Another advantage is high efficiency since the EVP can produce a given force with much lower power consumption than a voice-coil actuator (like those used in typical cone drivers). It is believed that the EVP is more efficient than the electrostatic venturi membrane pumps/transducers (EVMPs) disclosed and taught in the embodiments disclosed in the Pinkerton '426 Patent and the Pinkerton '073 Application.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “substantially perpendicular” and “substantially parallel” is meant to encompass variations of in some embodiments within ±10° of the perpendicular and parallel directions, respectively, in some embodiments within ±5° of the perpendicular and parallel directions, respectively, in some embodiments within ±1° of the perpendicular and parallel directions, respectively, and in some embodiments within ±0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

1. An electromagnet venturi membrane-based pump/transducer that is operable to produce a flow of fluid, wherein the electromagnet venturi membrane-based pump/transducer comprises:
(a) a membrane having a first side and a second side, wherein the membrane is operable to move along an axis;
(b) a ferromagnetic material, wherein (i) the membrane comprises the ferromagnetic material, (ii) the ferromagnetic material is attached to the membrane, or (iii) both;
(c) a perforated structure having a first side facing the first side of the membrane, wherein the perforated structure has perforations to provide for the flow of the fluid through the perforated structure;
(d) an electromagnet on the first side of the perforated structure such that the electromagnet is facing the ferromagnetic material; and
(e) a venturi plate positioned on the second side of the membrane, wherein
(i) the electromagnet is operable to pull the membrane to a set point and then oscillate the membrane about this point, and
(ii) the oscillation of the membrane produces the flow of the fluid.

2. The electromagnet venturi membrane-based pump/transducer of claim 1, wherein the ferromagnetic material is attached to the membrane.

3. The electromagnet venturi membrane-based pump/transducer of claim 2, wherein the ferromagnetic material is a ceramic compound.

4. The electromagnet venturi membrane-based pump/transducer of claim 3, wherein the ceramic compound is ferrite.

5. The electromagnet venturi membrane-based pump/transducer of claim 4, wherein the ferrite is Fe₃O₄ or BaFe₁₂O₁₉.

6. The electromagnet venturi membrane-based pump/transducer of claim 1, wherein the membrane comprises the ferromagnetic material.

7. The electromagnet venturi membrane-based pump/transducer of claim 6, wherein the membrane is comprised of ferromagnetic steel.

8. The electromagnet venturi membrane-based pump/transducer of claim 1, wherein the electromagnet comprises a metal coil surrounded by a ferromagnetic material.

9. The electromagnet venturi membrane-based pump/transducer of claim 8, wherein the metal coil is a copper coil.

10. The electromagnet venturi membrane-based pump/transducer of claim 1, wherein the ferromagnetic material is ferrite or steel.

11. The electromagnet venturi membrane-based pump/transducer of claim 1, wherein the electromagnet is connected to an electronic circuit that controls the oscillation of the membrane.

12. The electromagnet venturi membrane-based pump/transducer of claim 11, wherein the electronic circuit provides electronic current having a DC component and an AC component.

13. The electromagnet venturi membrane-based pump/transducer of claim 1, wherein the oscillation of the membrane has a mechanical resonance of around 20 kHz.

14. The electromagnet venturi membrane-based pump/transducer of claim 1, wherein the oscillation of the membrane has a non-resonant mode.

15. The electromagnet venturi membrane-based pump/transducer of claim 1, wherein the oscillation of the membrane produces sound waves.

16. The electromagnet venturi membrane-based pump/transducer of claim 1, wherein the oscillation of the membrane produces ultrasonic waves.

17. The electromagnet venturi membrane-based pump/transducer of claim 1, wherein the oscillation of the membrane modulates deflection of the membrane at audio frequencies to produce an audio signal.

18. The electromagnet venturi membrane-based pump/transducer of claim 1, wherein the fluid is air.

19. The electromagnet venturi membrane-based pump/transducer of claim 1, wherein the fluid is water.

20. A system comprising a plurality of the electromagnet venturi membrane-based pump/transducers of claim 1.

21. The system of claim 20, wherein the system is an audio system.

22. The system of claim 20, wherein the system is a pump.

23. The system of claim 20, wherein the system is a fan.

24-46. (canceled)
